(19) United States
(12) Patent Application Publication
(10) Pub. No.: US 2024/0314301 A1
(43) Pub. Date: Sep. 19, 2024

(54) TEMPLATE-BASED INTRA MODE DERIVATION

(71) Applicant: INTERDIGITAL CE PATENT HOLDINGS, SAS, Paris (FR)

(72) Inventors: Philippe BORDES, Cesson-Sevigne (FR); Thierry DUMAS, Cesson-Sevigne (FR); Fabrice URBAN, Cesson-Sevigne (FR); Franck GALPIN, Cesson-Sevigne (FR)

(21) Appl. No.: 18/571,135

(22) PCT Filed: Jun. 15, 2022
(86) PCT No.: PCT/EP2022/066435

§ 371 Date: Dec. 15, 2023

(30) Foreign Application Priority Data
Jun. 23, 2021 (EP) 21305858.9

(51) Int. Cl. H04N 19/11; H04N 19/105; H04N 19/159; H04N 19/176

(52) U.S. Cl. CPC H04N 19/11; H04N 19/105; H04N 19/159; H04N 19/176

(57) ABSTRACT

In a particular implementation. video encoding or decoding may use decoder-side intra mode derivation (DIMD). An intra coding mode is selected based on a plurality of reconstructed samples in a template region adjacent to the block, and the samples in the block are predicted with intra prediction based on the selected intra coding mode. The intra coding mode may be selected by testing a plurality of candidate intra coding modes for cost (e.g., distortion) of predicting the template region from a set of reconstructed reference samples. In one example. the same reference samples used for intra predicting the current block are used to predict the template region. The shape and size of the template region may also depend on the candidate intra mode. The plurality of candidate intra coding modes can be all or a subset of the directional modes. or all or a subset of the MPM modes.

### TECHNICAL FIELD

The present embodiments generally relate to a method and an apparatus for template-based intra prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method of video encoding or decoding is provided, comprising: for each of a plurality of candidate intra coding modes, obtaining a prediction of a template region adjacent to a block of a picture, using a respective candidate intra coding mode and a set of reference samples; determining a cost of using said respective candidate intra coding mode to predict said template region; selecting an intra coding mode from said plurality of candidate intra coding modes based on said cost; and predicting samples in said block with intra prediction based on said selected intra coding mode and said set of reference samples.

According to another embodiment, a method of video encoding or decoding is provided, comprising: for each of a plurality of candidate intra coding modes, obtaining a template region adjacent to a block of a picture, based on a respective candidate intra coding mode; obtaining a prediction of said template region, based on said respective candidate intra coding mode; determining a cost of using said respective candidate intra coding mode to predict said template region; selecting an intra coding mode from said plurality of candidate intra coding modes based on said cost; and predicting samples in said block with intra prediction based on said selected intra coding mode.

According to another embodiment, an apparatus for video encoding or decoding is presented, comprising one or more processors, wherein said one or more processors are configured to: for each of a plurality of candidate intra coding modes, obtain a prediction of a template region adjacent to a block of a picture, using a respective candidate intra coding mode and a set of reference samples; determine a cost of using said respective candidate intra coding mode to predict said template region; select an intra coding mode from said plurality of candidate intra coding modes based on said cost; and predict samples in said block with intra prediction based on said selected intra coding mode and said set of reference samples.

According to another embodiment, an apparatus for video encoding or decoding is presented, comprising one or more processors, wherein said one or more processors are configured to: for each of a plurality of candidate intra coding modes, obtain a template region adjacent to a block of a picture, based on a respective candidate intra coding mode; obtain a prediction of said template region, based on said respective candidate intra coding mode; determine a cost of using said respective candidate intra coding mode to predict said template region; select an intra coding mode from said plurality of candidate intra coding modes based on said cost; and predict samples in said block with intra prediction based on said selected intra coding mode.

One or more embodiments also provide a computer program comprising instructions which when executed by one or more processors cause the one or more processors to perform the encoding method or decoding method according to any of the embodiments described above. One or more of the present embodiments also provide a computer readable storage medium having stored thereon instructions for encoding or decoding video data according to the methods described above.

One or more embodiments also provide a computer readable storage medium having stored thereon a bitstream generated according to the methods described above. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4A illustrates intra prediction directions in HEVC, and FIG. 4B illustrates intra prediction directions in VVC.

FIG. 5 illustrates reference samples for intra prediction. The pixel values at co-ordinates (x, y) are indicated by P(x, y).

FIG. 6 illustrates wide-angle intra prediction.

FIG. 7 illustrates the planar mode.

FIG. 8 illustrates a process for decoding an intra mode block.

FIG. 9 illustrates template-based intra mode derivation.

FIG. 10 illustrates the state-of-the-art DIMD process.

FIG. 11A illustrates 93 intra prediction directions, and FIG. 11B illustrates that intra prediction directions depend on the value of (predIntraMode, intraPredAngle).

FIG. 12A and FIG. 12B illustrate that the list of reference sample values used for building intra prediction depends on the value of (predIntraMode, intraPredAngle).

FIG. 13 illustrates a DIMD process where the template depends on the intra prediction mode, according to an embodiment.

FIG. 14A and FIG. 14B illustrate building the prediction samples of the template from regular reference samples (refIdx=0), according to an embodiment.

FIG. 15A and FIG. 15B illustrate building the prediction samples of the template from regular reference samples (refIdx>0), according to an embodiment.

### DETAILED DESCRIPTION

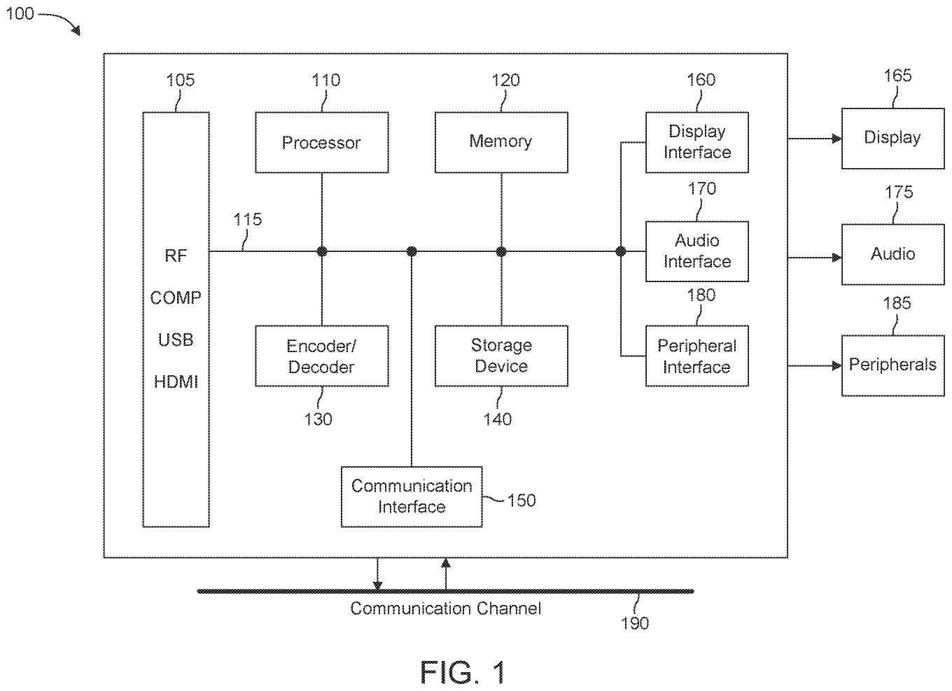

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130 ) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

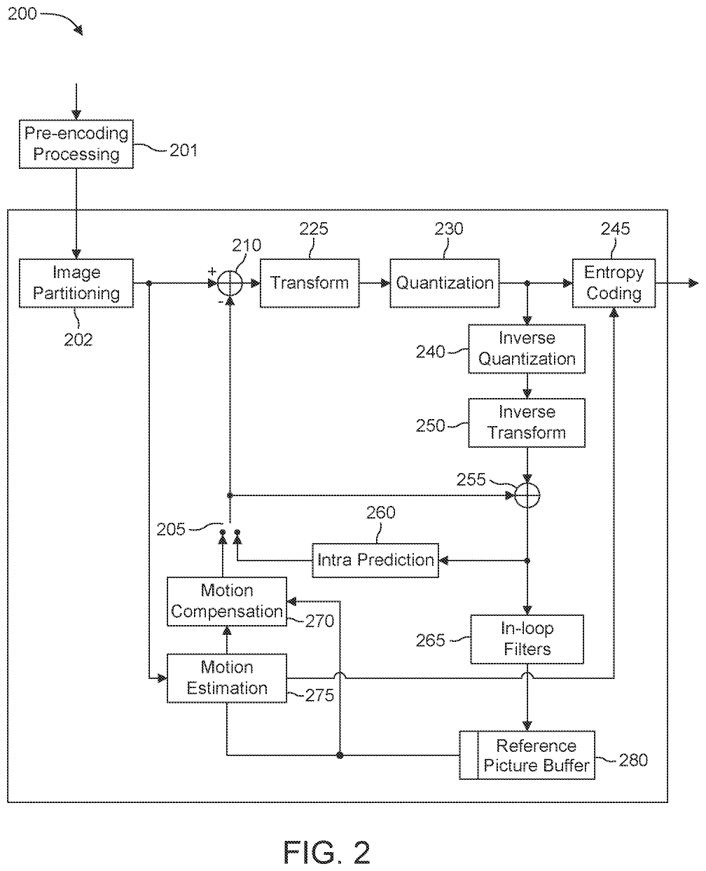

FIG. 2 illustrates an example video encoder 200, such as a a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i. e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

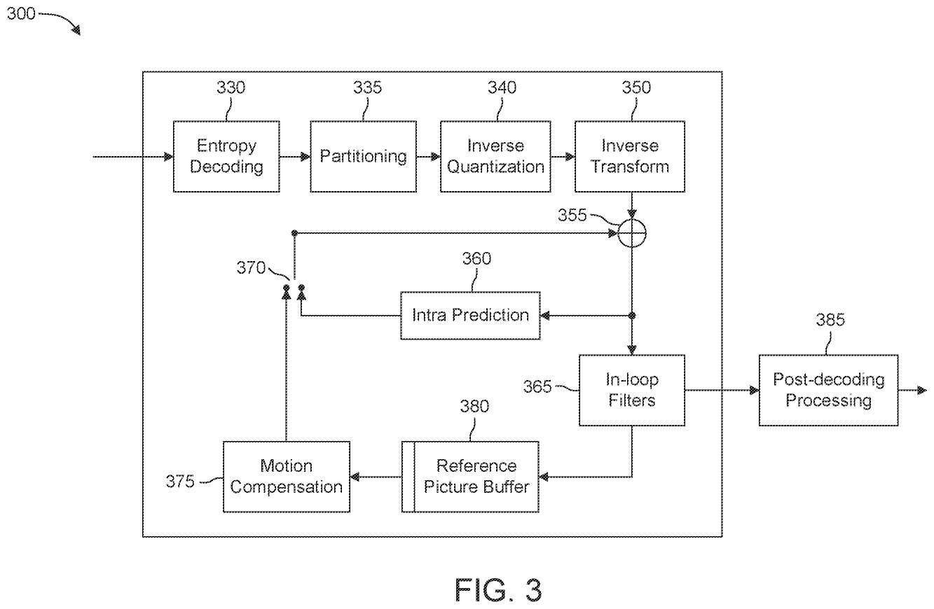

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

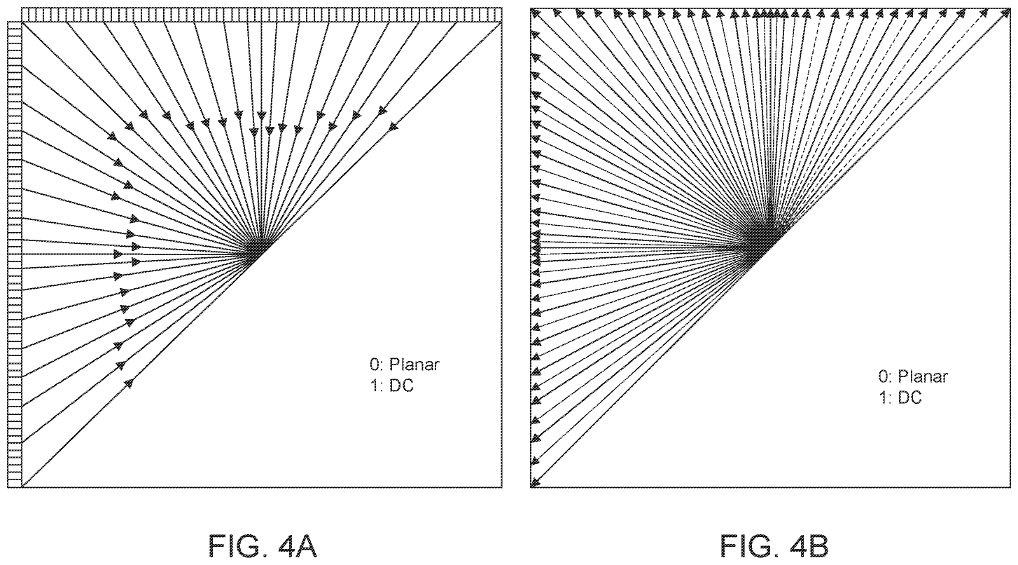

As described above, intra prediction allows predicting the current block from neighboring reconstructed samples (reference samples). Usually, the Planar and DC prediction modes are used to predict smooth and gradually changing regions, whereas angular prediction modes are used to capture different directional structures. HEVC supports 33 directional prediction modes which are indexed from 2 to 34; VVC supports 65 directional prediction modes which are indexed from 2 to 66. These prediction modes correspond to different prediction directions as illustrated in FIG. 4A (for HEVC) and FIG. 4B (for VVC).

The intra prediction process in HEVC and VVC consists of three steps:
Reference sample generation,
Intra sample prediction, and
Post-processing of predicted samples.

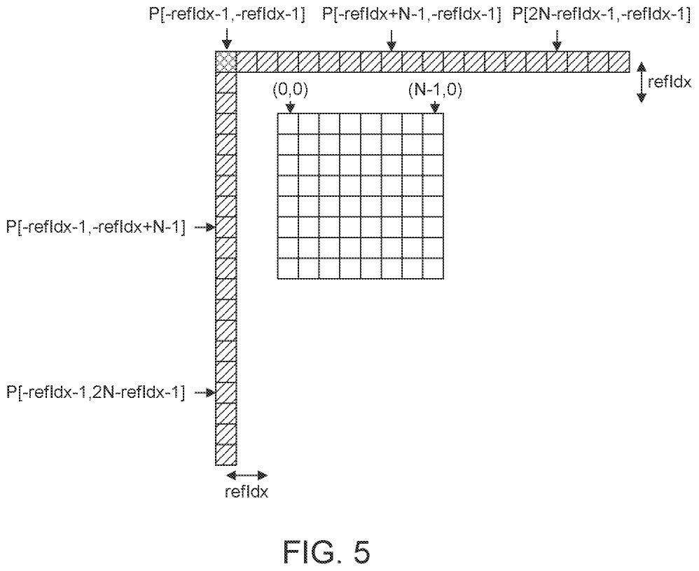

The reference sample generation process is illustrated in FIG. 5. The set of reference samples forms a L-shape. For a prediction unit (PU) of size N×N, a row of (2N+refIdx) decoded samples on the top and a column of (2N+refIdx) decoded samples are formed from the previously reconstructed top and top right, and left and bottom-left pixels respectively, where (refIdx+1) indicates the vertical distance (in number of pixels) between the reference sample row and the top row of the current PU, (refIdx+1) also denotes the horizontal distance (in number of pixels) between the reference sample column and the left-most column of samples of the current PU. In VVC, Multiple Reference Lines (MRL) can be used, and the reference row and column of samples may have a distance (d=refIdx+1) of more than one sample to the current block as depicted in FIG. 5.

The corner pixel at the top-left position is also used to fill up the gap between the top row and the left column references. If some of the samples on top or left are not available, because of the corresponding CUs not being in the same slice, or the current CU being at a frame boundary, etc., then a process of reference sample substitution is performed where the missing samples are copied from the available samples in a clockwise direction. Then, depending on the current CU size and the prediction mode, the reference samples are filtered using a specified filter.

The intra sample prediction consists of predicting the pixels of the target CU based on the reference samples. There exist different prediction modes. Usually, Planar and DC prediction modes are used to predict smooth and gradually changing regions, whereas angular (angle defined from 45 degrees to −135 degree in clockwise direction) prediction modes are used to capture different directional structures. For square blocks, HEVC supports 33 directional prediction modes which are indexed from 2 to 34. These prediction modes correspond to different prediction directions as illustrated in FIG. 4A. In VVC, there are 65 angular prediction modes, corresponding to the 33 angular directions defined in HEVC, and further 32 directions each corresponding to a direction mid-way between an adjacent pair (FIG. 4B).

In VVC, for non-square blocks, the regular directional intra predictions that are not allowed are replaced with additional wide-angle intra prediction modes, as illustrated in FIG. 6.

For a given angular prediction mode, the predictor samples on the reference arrays are copied along the corresponding direction inside the target PU. Some predictor samples may have integral locations, in which case they match with the corresponding reference samples; the location of other predictors will have fractional parts indicating that their locations will fall between two reference samples. In the latter case, the predictor samples are interpolated using the nearest reference samples. In HEVC, a linear interpolation of the two nearest reference samples is performed to compute the predictor sample value; in VVC, for interpolating the predictor samples, 4-tap filters fT[] are used which are selected depending on the intra mode direction.

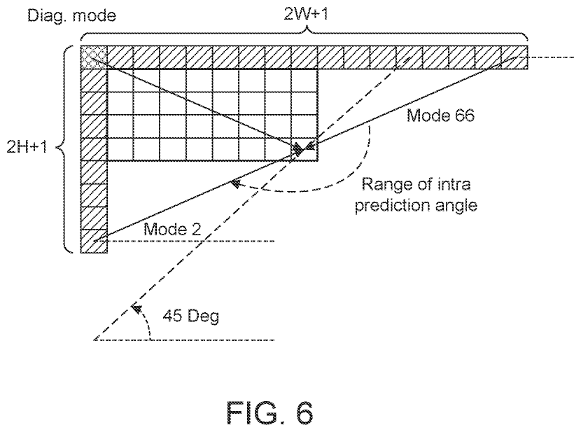

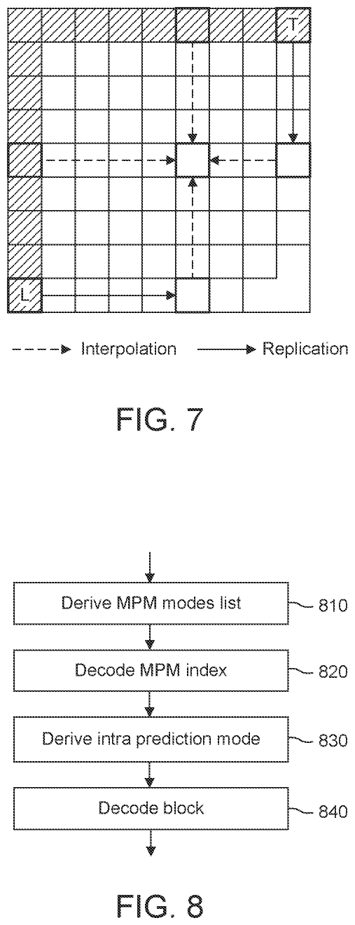

Besides directional modes, the DC mode fills-in the prediction with the average of the samples in the L-shape (except for rectangular CUs that use average of reference samples of the longer side), and the Planar mode interpolates reference samples spatially as depicted in FIG. 7.

### Intra Mode Coding

For better compression, the intra mode may be predicted from a list of six Most Probable Modes (MPMs). In an example as shown in FIG. 8, the MPM list is constructed (810) based on intra modes of the reconstructed left and the reconstructed above neighboring blocks (if coded in intra) and on default intra modes. If the mode is one among the MPMs, its index is decoded (820) with CABAC, otherwise the mode is one of the 61 non-MPM modes and a Truncated Binary Code (TBC) is used. After the intra prediction mode is derived (830), the block can be decoded (840) accordingly.

### Template-Based Intra Mode Derivation Using MPMs (TIMD or DIMD)

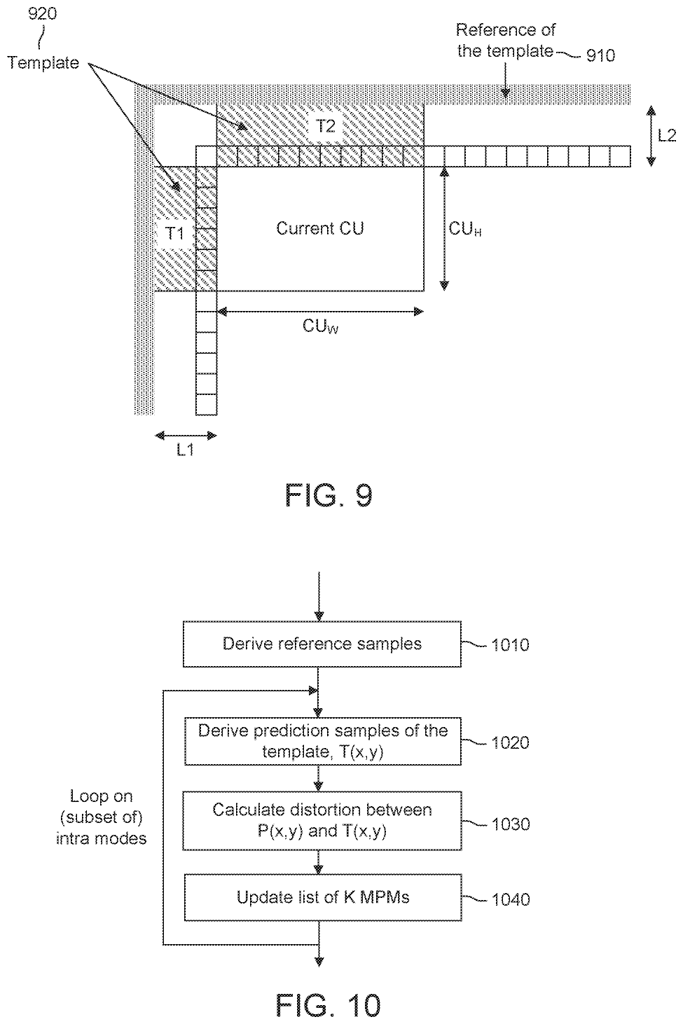

A decoder-side intra mode derivation (DIMD) method is depicted in FIG. 9 and FIG. 10. DIMD allows deriving or updating the list of MPMs. In DIMD, instead of signaling the intra mode explicitly, the information is derived at both the encoder and decoder from the neighboring reconstructed samples of the current block. The template (920, indicated by the hatched region in FIG. 9) specifies a set of already reconstructed samples, which are used to derive the intra mode. The template size is denoted as the number of samples within the template that extends to the above and the left of the target block, i.e., L1 and L2. When the block is square, L1 may be equal to L2, i.e., L1=L2=L. For example, a template size of 2 (i.e., L=2) is used for 4×4 and 8×8 blocks and a template size of 4 (i.e., L=4) is used for 16×16 and larger blocks. The reference of template (910, indicated by the dotted region in FIG. 9) refers to a set of neighboring samples from above and left of the template.

As illustrated in FIG. 10, for each (or for a subset of) (angular) intra prediction mode, an encoder or decoder obtains (1010) the reference samples (910) and the reconstructed samples for the template (920). For the samples in the template (920, P(x, y)), prediction samples (T(x, y)) are obtained (1020) from the reference samples (910) of the template, for example, using the same process as the regular intra prediction samples building. Then the encoder or decoder calculates (1030) the distortion (e.g., absolute difference, SAD) between the reconstructed template samples P(x, y) and its prediction samples T(x, y). The K intra prediction modes that yield the K smallest distortions are selected as the K MPMs (1040). If K is equal to 1, the intra mode with minimum SAD is selected as the final intra prediction mode of the current block.

In a variant, the MPM list is updated with additional neighboring intra modes (if not present in the list) and with other non-angular modes (e.g., DC, Planar). In another variant, a flag is coded in the bitstream to indicate whether the DIMD method is used or the regular method is used for coding the intra prediction mode. In the work described in an article by Y. Wang et al., entitled “EE2-related: Template-based intra mode derivation using MPMs,” document JVET-V0098, 22 nd Meeting, by teleconference, 20-28 Apr. 2021, when the DIMD flag is true, the SAD is computed for the regular MPM modes only and the mode with minimal SAD is selected. If the DIMD flag is false, the regular MPM index coding is used.

### Intra Sub-Partitions

The Intra Sub-Partitions (ISP) tool divides an intra-predicted luma block vertically or horizontally into two or four sub-partitions depending on the block size. For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partition prediction signals are only located at the left and above sides of the sub-partitions. All sub-partitions share the same intra mode.

There are some drawbacks and limitations with the current DIMD. For example, the reference samples may be relatively far from (distance=L) the current block, which may correspond to regions different from the current block. In addition, the reference samples used by DIMD are not the same as those used for building the final intra prediction for the current block.

### Reference Samples for Building the Intra Prediction in VVC

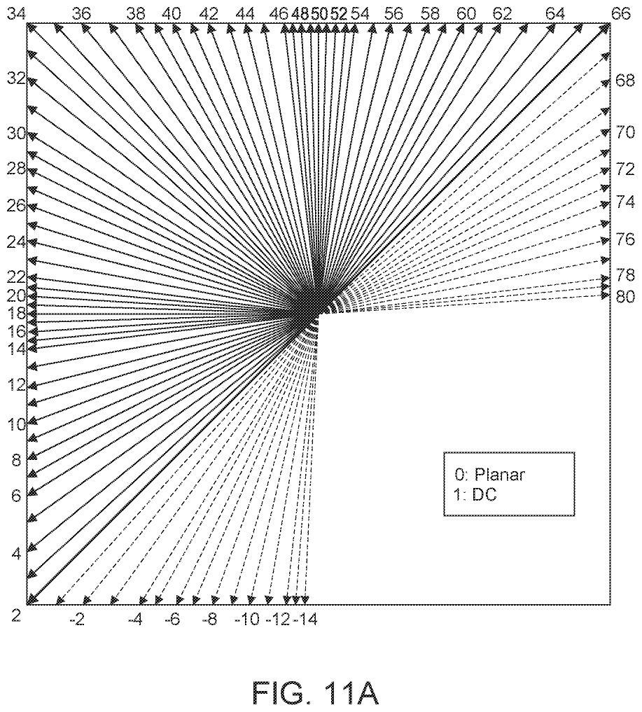

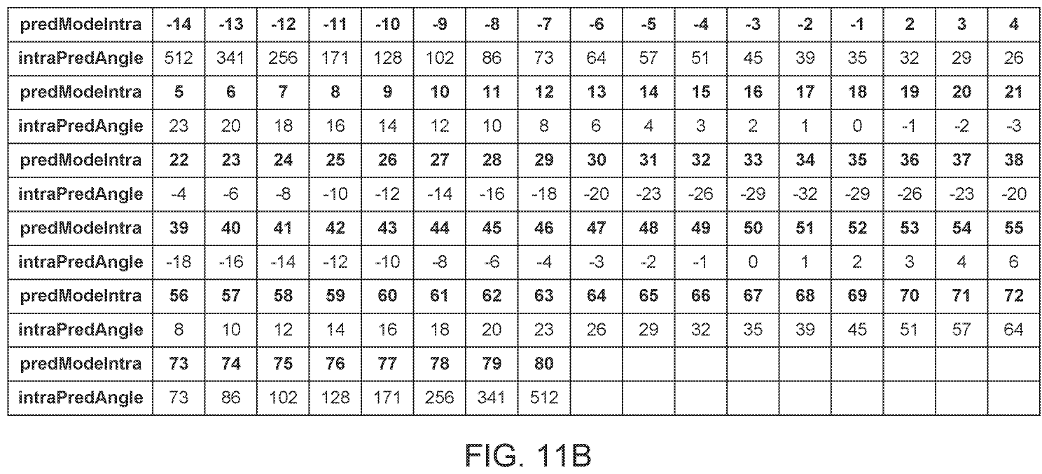

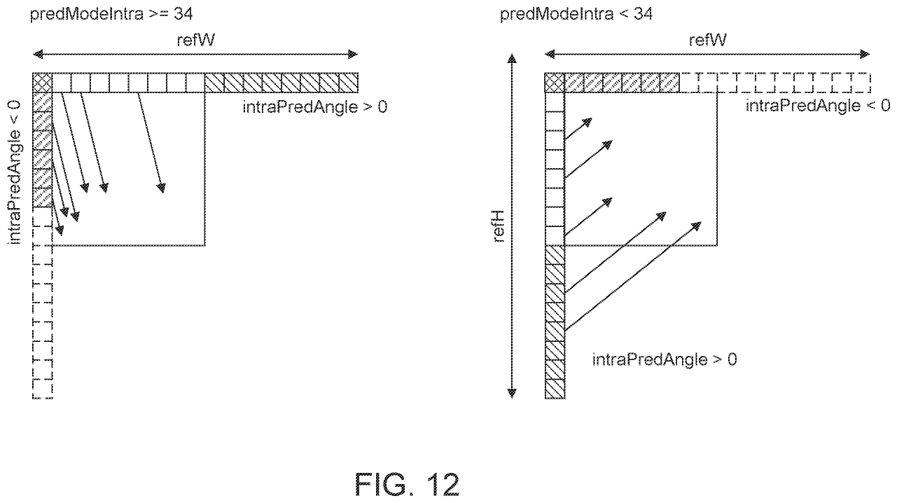

FIG. 11A illustrates the 93 prediction directions in VVC, where the dashed directions are associated with the wide-angle modes that are only applied to non-square blocks. FIG. 11B specifies the mapping table between (predModeIntra) and the angle parameter (intraPredAngle). As shown in FIG. 12 for VVC, the set of reference samples used for building intra prediction depends on the value of (predIntraMode, intraPredAngle).

In the following, we consider that the DIMD is used with all regular (directional modes, or directional modes plus DC and Planar mode) intra modes or a subset “G” of intra modes. G can be the regular MPMs, a subset/superset of regular MPMs or a set of pre-defined intra modes for example. The K modes (K≤G) with the smallest SAD will allow to build the MPM list and an MPM index is coded to indicate the MPM intra mode to be used for current CU. In an example, K=1 and the MPM index is not coded.

Possibly, a DIMD flag is coded per CU to indicate whether the DIMD method is used or not. Using DIMD with a reduced set of intra modes (e.g., use of DIMD with the regular MPM modes, or with an extended MPM list, or with an arbitrary reduced set of directions) allows reducing the decoder-side complexity.

In an embodiment, if DIMD is enabled, then the MRL refIdx is not coded but inferred to be zero, and the ISP flag is not coded and inferred to zero.

In an embodiment, if DIMD and ISP are enabled together, then the intra mode is determined for the first sub-partition and is the same for the other sub-partitions. In another embodiment, DIMD is used to derive the intra mode for all the ISP sub-partitions successively.

### Template Depends on the Intra Mode

In the existing DIMD, the template is composed of two regions T1 and T2 as shown in FIG. 9, corresponding to left and top templates, of size (CU_{H}×L1) and (CU_{W}×L2) respectively, where CU_{H} and CU_{W} are the height and width of the CU respectively.

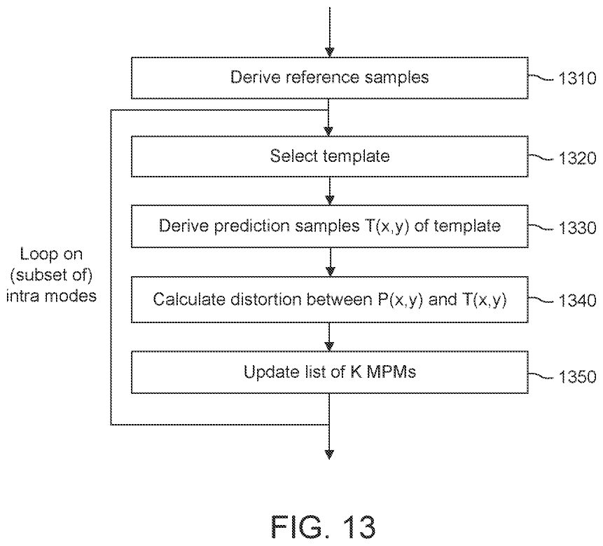

In one embodiment, as illustrated in FIG. 13, the DIMD process for deriving the MPM list as shown in FIG. 10 is modified so that the template is composed of T1, T2 or (T1+T2) depending on the value of the intra prediction mode (1320). For example, if the intra prediction mode corresponds to a vertical direction using top reference samples only (angle<a threshold, e.g., −45 degree or predIntraMode>50), the template is set to T2. If the intra prediction mode corresponds to a horizontal direction using left reference samples only (angle>0 degree or predIntraMode<18) then the template is set to T1. In other cases, the template is equal to T1+T2.

In another example, the template is composed of T1, T2 or (T1+T2) depending on the MPM candidate position relatively to the current CU. For example, if the MPM candidate is from the top CU, then T2 is used. If the MPM candidate is from the left CU, then T1 is used. In other case, T1+T2 is used or the previous method based on the predIntraMode value is used.

In another example, the encoder or decoder derives three MPM intra modes corresponding to the three intra prediction modes that minimize SAD with T1, T2 and (T1+T2) templates respectively. The three MPMs are added to the MPM list, while duplicated modes are pruned.

Referring back to FIG. 13, for each (or for a subset of) (angular) intra prediction mode, an encoder or decoder obtains (1310) the reference samples. The template is selected (1320), for example, based on the intra prediction mode or the MPM position as described above. For the samples in the template (P(x, y)), prediction samples (T(x, y)) are obtained (1330) from the reference samples of the template. Then the encoder or decoder calculates (1340) the distortion (e.g., absolute difference, SAD) between the reconstructed template samples P(x, y) and its prediction samples T(x, y). Note that because the template may vary with the intra prediction mode, the distortion can be normalized in order to be comparable for different intra prediction modes. The K intra prediction modes that yield the K smallest distortions are selected as the K MPMs (1350). If K is equal to 1, the intra mode with minimum SAD is selected as the final intra prediction mode of the current block. Note that the method as illustrated in FIG. 13 can be applied at the encoder or decoder.

### Use Regular Reference Samples for Building Template Prediction Samples

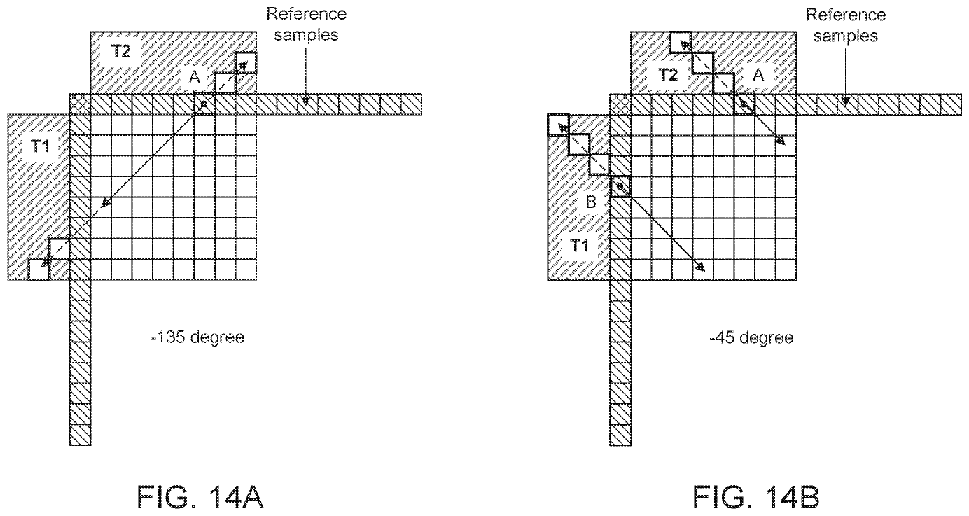

In one embodiment, the process for building the prediction samples of the template is modified as follows:
The reference samples of the template are set equal to the reference samples of the regular intra prediction process (see ref[x] in the descriptions with respect to the changes to the standard specification).
The process for building the prediction samples of the template is the same as the regular process (predSamples[x][y] in the descriptions with respect to the changes to the standard specification), except that the predictor samples on the reference arrays are copied along the opposite direction or continue in the same direction as depicted in FIG. 14, depending on the value of intraPredMode. The same conditions for interpolating the predictor samples applies (see eq. 336, 337, 338, eq. 346, 347, 348).

Two examples are depicted in FIG. 14. In FIG. 14A, for the intra mode direction −135 degree, reference sample A allows filling the prediction samples for the current CU along the direction represented with the arrow with the regular prediction process. In the proposed scheme, sample A is also used to predict samples in template T1 by continuing filling in the same direction (dashed arrow). Sample A is also used to predict samples in template T2 by filling in the opposite direction (dashed arrow).

In FIG. 14B, for the intra mode direction −45 degree, reference samples A and B allow filling the prediction samples for the current CU along the direction represented with the arrows with the regular prediction process. In the proposed scheme, samples A and B are also used to predict samples in T2 and T1 respectively in the opposite direction (dashed arrows).

In another embodiment, two methods for deriving or filling the template prediction samples are used for each intra mode so that (2×G) SADs are computed. One method is the proposed one (see above), and the other method is the regular DIMD method.

In another embodiment, the reference samples for predicting the template correspond to refIdx=0, even if refIdx=0 is not selected by MRL for the current CU. In another embodiment, if refIdx is not equal to zero, the reference samples are built as in VVC but the filling is carried out as if they were located at position refIdx=0, as depicted in FIG. 14.

In another embodiment, if refIdx is not equal to zero, the reference samples are built as in

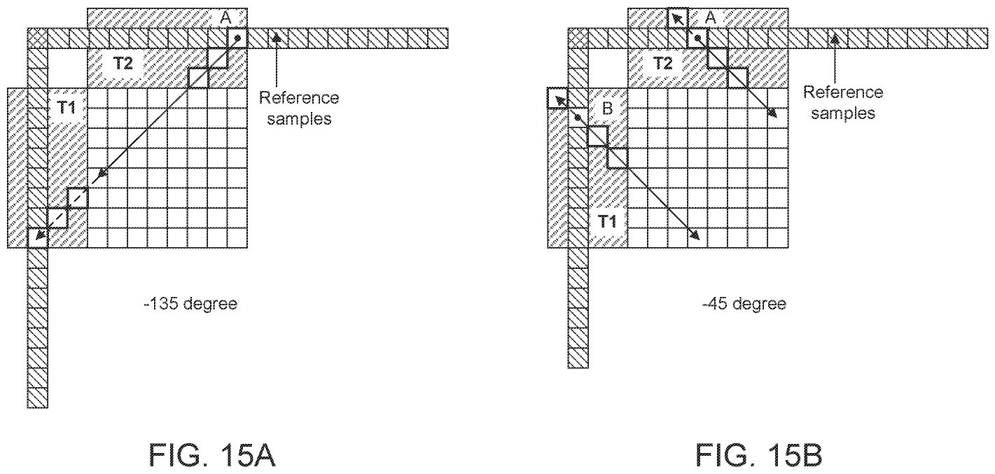

VVC but the filling is carried out with the proposed method, with reference samples located at their actual position, as depicted in FIG. 15A and FIG. 15B.

In another embodiment, if the regular equations for building the prediction samples cannot be used (see condition on refMax in the descriptions with respect to the changes to the standard specification), the template prediction samples are set equal to the neighboring reconstructed samples.

In another embodiment, if the regular equations for building the prediction samples cannot be used (see condition on refMax in the descriptions with respect to the changes to the standard specification), the template samples are set to “undefined” and not used in the distortion computation.

### Text Specification for Building Template Samples for Intra Prediction

In the following text, a portion of the specification “Versatile Video Coding (draft 10)”, by Benjamin Bross, Jianle Chen, Shan Liu, and Ye-Kui Wang (JVET-S2001), 19 th meeting, 22 June-1 Jul. 2020, is modified to include the process for building the template prediction samples. The changes are in italics. Before the modification, this portion of the specification describes the process of predicting the samples of the current CU (regular intra directional prediction mode). After the modification, this specification portion additionally describes the process of building the prediction samples of the template. This is an example of modification of the regular intra mode prediction specification.

First. the values of the template prediction samples predSamples [x][y], with x=0 . . . nTbW−1, y=−1 . . . −L2 and x=−1 . . . −L1, y=0 . . . nTbH−1 are initialized with neighboring reconstructed values p[x][y]. Let's denote the transform block size nTbW×nTbH.

The following process is invoked for deriving the values of the prediction samples predSamples[x][y], with x=0 . . . nTbW−1, y=0 . . . nTbH−1 and for deriving the values of the template prediction samples predSamples [x][y], with x=0 . . . nTbW−1, y=−1 . . . −L2 and x=−1 . . . −L1, y=0 . . . nTbH−1 as follows:
If predModeIntra is greater than or equal to 34, the following ordered steps apply:
   1. The reference sample array ref[x] is specified as follows:
      The following applies:

$$ref [ x ] = p [ - 1 - refIdx + x ] [ - 1 - refIdx ] , with x = 0 … nTbW + refIdx + 1 \qquad ( 329 )$$

If intraPredAngle is less than 0, the main reference sample array is extended as follows:

$$ref [ x ] = p [ - 1 - refIdx ] [ - 1 - refIdx + Min ( ( x * invAngle + 256 ) >> 9 , nTbH ) ] , with x = - nTbH … - 1 \qquad ( 330 )$$

Otherwise, the following applies:

$$ref [ x ] = p [ - 1 - refIdx + x ] [ - 1 - refIdx ] , with x = nTbW + 2 + refIdx … refW + refIdx \qquad ( 331 )$$

The additional samples ref[refW+refIdx+x] with x=1 . . . (Max(1,nTbW/nTbH)*refIdx+1) are derived as follows:

$$ref [ refW + refIdx + x ] = p - 1 + refW ] [ - 1 - refIdx ] \qquad ( 332 )$$

The value refMax is set equal to (Max(1,nTbW/nTbH)*refIdx+1)
2. The values of the prediction samples predSamples[x][y], with x=0 . . . nTbW−1, y=0 . . . nTbH−1 and the values of the template prediction samples predSamples[x][y], with x=0 . . . nTbW−1, y=−1 . . . −L2 and x=−1 . . . −L1, y=0 . . . nTbH−1, are derived as follows:
   The index variable iIdx and the multiplication factor iFact are derived as follows:

$$iIdx = ( ( ( abs ( y ) + refIdx ) * intraPredAngle ) >> 5 ) + refIdx \qquad ( 333 )$$

$$i Fact = ( ( abs ( y ) + 1 + refIdx ) * intraPredAngle ) \& 31 \qquad ( 334 )$$

If cIdx is equal to 0 (Luma component), the following applies:
   The interpolation filter coefficients fT[j] with j=0 . . . 3 are derived as follows:

$$fT [ j ] = filterFlag ? fG [ i Fact ] [ j ] : fC [ i Fact ] [ j ] \qquad ( 335 )$$

If (x+iIdx+i) with i=0 . . . 3 is greater or equal to 0 and less or equal to refMax. the value of the prediction samples predSamples[x][y] is derived as follows:

$$predSamples [ x ] [ y ] = Clip1 ( ( ( {\sum }_{i = 0 … 3} fT [ i ] * ref [ x + iIdx + i ] ) + 32 ) >> 6 ) \qquad ( 336 )$$

Otherwise (cIdx is not equal to 0, chroma component), depending on the value of iFact, the following applies:
   If iFact is not equal to 0, and if (x+iIdx+i) with i=1 . . . 2 is greater or equal to 0 and less or equal to refMax, the value of the prediction samples predSamples[x][y] is derived as follows:

$$predSamples [ x ] [ y ] = ( ( 32 - i Fact ) * ref [ x + iIdx + 1 ] + i Fact * ref [ x + iIdx + 2 ] + 16 >> 5 \qquad ( 337 )$$

Otherwise, if (x+iIdx+1) is greater or equal to 0 and less or equal to refMax, the value of the prediction samples predSamples[x][y] is derived as follows:

$$predSamples [ x ] [ y ] = ref [ x + iIdx + 1 ] \qquad ( 338 )$$

Otherwise (predModeIntra is less than 34), the following ordered steps apply:
   1. The reference sample array ref[x] is specified as follows:
      The following applies:

$$ref [ x ] = p [ - 1 - refIdx ] [ - 1 - refIdx + x ] , with x = 0 … nTbH + refIdx + 1 \qquad ( 339 )$$

If intraPredAngle is less than 0, the main reference sample array is extended as follows:

$$ref [ x ] = p [ - 1 - refIdx + Min ( ( x * invAngle + 256 ) >> 9 , nTbW ) ] [ - 1 - refIdx ] , with x = - nTbW … - 1 \qquad ( 340 )$$

Otherwise, the following applies:

$$ref [ x ] = p [ - 1 - refIdx ] [ - 1 - refIdx + x ] , with x = nTbH + 2 + refIdx … refH + refIdx \qquad ( 341 )$$

The additional samples ref[refH+refIdx+x] with x=1 . . . (Max(1,nTbH/nTbW)*refIdx+1) are derived as follows:

$$ref [ refH + refIdx + x ] = p [ - 1 - refIdx ] [ - 1 + refH ] \qquad ( 342 )$$

The value refMax is set equal to (Max(1,nTbH/nTbW)*refIdx+1)
2. The values of the prediction samples predSamples[x][y], with x=0 . . . nTbW−1, y=0 . . . nTbH−1 and the values of the template prediction samples predSamples[x][y], with x=0 . . . nTbW−1, y=−1 . . . −L2 and x=−1 . . . −L1, y=0 . . . nTbH−1, are derived as follows:
   The index variable iIdx and the multiplication factor iFact are derived as follows:

$$iIdx = ( ( ( abs ( x ) + refIdx ) * intraPredAngle ) >> 5 ) + refIdx \qquad ( 343 )$$

$$i Fact = ( ( abs ( x ) + 1 + refIdx ) * intraPredAngle ) \& 31 \qquad ( 344 )$$

If cIdx is equal to 0 (luma component), the following applies:
   The interpolation filter coefficients fT[j] with j=0 . . . 3 are derived as follows:

$$fT [ j ] = filterFlag ? fG [ i Fact ] [ j ] : fC [ i Fact ] [ j ] \qquad ( 345 )$$

If (y+iIdx+i) with i=0 . . . 3 is greater or equal to 0 and less or equal to refMax. the value of the prediction samples predSamples[x][y] is derived as follows:

$$predSamples [ x ] [ y ] = Clip1 ( ( ( {\sum }_{i = 0 … 3} fT [ i ] * ref [ y + iIdx + i ] ) + 32 ) >> 6 ) \qquad ( 346 )$$

Otherwise (cIdx is not equal to 0, chroma component), depending on the value of iFact, the following applies:
   If iFact is not equal to 0, and if (y+iIdx+i) with i=1 . . . 2 is greater or equal to 0 and less or equal to refMax, the value of the prediction samples predSamples[x][y] is derived as follows:

$$predSamples [ x ] [ y ] = ( ( 32 - i Fact ) * ref [ y + iIdx + 1 ] + i Fact * ref [ y + iIdx + 2 ] + 16 >> 5 \qquad ( 347 )$$

Otherwise, if (y+iIdx+1) is greater or equal to 0 and less or equal to refMax, the value of the prediction samples predSamples[x][y] is derived as follows:

$$predSamples [ x ] [ y ] = ref [ y + iIdx + 1 ] \qquad ( 348 )$$

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the intra prediction modules (260, 360), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. (canceled)

2. A method of video decoding, comprising:
for each candidate intra coding mode of a plurality of candidate intra coding modes for a block of a picture:
obtaining a template region adjacent to said block, based on said candidate intra coding mode,
obtaining a prediction of said template region, based on said candidate intra coding mode, and
determining a respective cost of using said candidate intra coding mode to predict said template region;
selecting an intra coding mode from said plurality of candidate intra coding modes based on said respective costs;
predicting samples in said block with intra prediction based on said selected intra coding mode; and
decoding said block based on said predicted samples for said block.

3-7. (canceled)

8. The method of claim 2, wherein said template region only includes reconstructed samples above said block responsive to that said candidate intra coding mode is a vertical mode that belongs to a pre-determined set of vertical modes or that only uses above reference samples for intra prediction.

9. The method of claim 2, wherein said template region only includes reconstructed samples above said block responsive to that said candidate intra coding mode corresponds to an MPM candidate from a top block.

10. (canceled)

11. The method of claim 2, wherein said template region only includes reconstructed samples to the left of said block responsive to that said candidate mode is a horizontal mode that belongs to a pre-determined set of horizontal modes or because that only uses left reference samples for intra prediction.

12. The method of claim 2, wherein said template region only includes reconstructed samples to the left of said block responsive to that said candidate mode corresponds to an MPM candidate from a left block.

13-20. (canceled)

21. A method of video encoding, comprising:
for each candidate intra coding mode of a plurality of candidate intra coding modes for a block of a picture:
obtaining a template region adjacent to said block, based on said candidate intra coding mode,
obtaining a prediction of said template region, based on said candidate intra coding mode, and
determining a respective cost of using said candidate intra coding mode to predict said template region;
selecting an intra coding mode from said plurality of candidate intra coding modes based on said respective costs;
predicting samples in said block with intra prediction based on said selected intra coding mode; and
encoding said block based on said predicted samples for said block.

22. The method of claim 21, wherein said template region only includes reconstructed samples above said block responsive to that said candidate intra coding mode is a vertical mode that belongs to a pre-determined set of vertical modes or that only uses above reference samples for intra prediction.

23. The method of claim 21, wherein said template region only includes reconstructed samples above said block responsive to that said candidate intra coding mode corresponds to an MPM candidate from a top block.

24. The method of claim 21, wherein said template region only includes reconstructed samples to the left of said block responsive to that said candidate mode is a horizontal mode that belongs to a pre-determined set of horizontal modes or because that only uses left reference samples for intra prediction.

25. The method of claim 21, wherein said template region only includes reconstructed samples to the left of said block responsive to that said candidate mode corresponds to an MPM candidate from a left block.

26. An apparatus for video encoding, comprising at least a memory and one or more processors, wherein said one or more processors are configured to:
for each candidate intra coding mode of a plurality of candidate intra coding modes for a block of a picture:
obtain a template region adjacent to said block, based on said candidate intra coding mode,
obtain a prediction of said template region, based on said candidate intra coding mode, and
determine a respective cost of using said candidate intra coding mode to predict said template region;
select an intra coding mode from said plurality of candidate intra coding modes based on said respective costs;
predict samples in said block with intra prediction based on said selected intra coding mode; and
encode said block based on said predicted samples for said block.

27. The apparatus of claim 26, wherein said template region only includes reconstructed samples above said block responsive to that said candidate intra coding mode is a vertical mode that belongs to a pre-determined set of vertical modes or that only uses above reference samples for intra prediction.

28. The apparatus of claim 26, wherein said template region only includes reconstructed samples above said block responsive to that said candidate intra coding mode corresponds to an MPM candidate from a top block.

29. The apparatus of claim 26, wherein said template region only includes reconstructed samples to the left of said block responsive to that said candidate mode is a horizontal mode that belongs to a pre-determined set of horizontal modes or because that only uses left reference samples for intra prediction.

30. The apparatus of claim 26, wherein said template region only includes reconstructed samples to the left of said block responsive to that said candidate mode corresponds to an MPM candidate from a left block.

31. An apparatus for video decoding, comprising at least a memory and one or more processors, wherein said one or more processors are configured to:
for each candidate intra coding mode of a plurality of candidate intra coding modes for a block of a picture:
obtain a template region adjacent to said block, based on said candidate intra coding mode,
obtain a prediction of said template region, based on said candidate intra coding mode, and
determine a respective cost of using said candidate intra coding mode to predict said template region;
select an intra coding mode from said plurality of candidate intra coding modes based on said respective costs;
predict samples in said block with intra prediction based on said selected intra coding mode; and
decode said block based on said predicted samples for said block.

32. The apparatus of claim 31, wherein said template region only includes reconstructed samples above said block responsive to that said candidate intra coding mode is a vertical mode that belongs to a pre-determined set of vertical modes or that only uses above reference samples for intra prediction.

33. The apparatus of claim 31, wherein said template region only includes reconstructed samples above said block responsive to that said candidate intra coding mode corresponds to an MPM candidate from a top block.

34. The apparatus of claim 31, wherein said template region only includes reconstructed samples to the left of said block responsive to that said candidate mode is a horizontal mode that belongs to a pre-determined set of horizontal modes or because that only uses left reference samples for intra prediction.

35. The apparatus of claim 31, wherein said template region only includes reconstructed samples to the left of said block responsive to that said candidate mode corresponds to an MPM candidate from a left block.
